(19) United States
(12) Patent Application Publication
(10) Pub. No.: US 2007/0132434 A1
(43) Pub. Date: Jun. 14, 2007

(54) Method and apparatus for improved voltage regulation

(76) Inventors: Jeffrey A. Carlson, Portland, OR (US); Edward P. Osburn, Tigard, OR (US)

Correspondence Address: BUCKLEY, MASCHOFF & TALWALKAR LLC, 50 LOCUST AVENUE, NEW CANAAN, CT, 06840, US

(21) Appl. No.: 11/300,612

(22) Filed: Dec. 14, 2005

(51) Int. Cl. G05F 1/00

(52) U.S. Cl. 323/222

(57) ABSTRACT

A system for voltage regulation may include a first switch comprising a first switch output, a second switch comprising a second switch output and a third switch comprising a third switch output coupled to the first switch output. The system may also include a first inductor coupled to the first switch output and the third switch output. The system may also have a second inductor coupled to the second switch output and a capacitor. The first inductor and second inductor may be coupled to each other at a node, and the capacitor may be coupled to the node.

### BACKGROUND

A voltage regulator may receive power from a power supply at first voltage and current values and convert the power to second voltage and current values. The converted voltage and current values may be suitable for providing power to an integrated circuit (IC) or other electric load. A voltage regulator may operate by generating a control pulse having a duty cycle that is roughly equal to a ratio of the desired output voltage (e.g. 1.2V) to the power supply voltage (e.g. 12V). The control pulse may be transmitted to a switch or switches that operate in conjunction with other circuitry to generate the output voltage.

FIG. 1 is a schematic design of a prior art buck voltage regulator 100. A high switch 120 and a low switch 130 of the regulator 100 each include a gate for receiving a high-side driver (“HS_DRV”) control signal and a low-side driver (“LS_DRV”) control signal, respectively. Upon commencing operation, a HS_DRV high control signal closes high switch 120 and LS_DRV low control signal opens low switch 130. As a result, a voltage source 110 is electrically coupled to an inductor 140. A resulting change in voltage across inductor 140, due to the electrical coupling of the voltage source 110 to the inductor 140, induces a current (designated as I_{Lout}) to flow through inductor 140. The current I_{Lout} is then conveyed through a parallel coupling of a capacitor 150 and a load 160. I_{Lout} then begins charging capacitor 150, thereby inducing a voltage across the parallel coupling of capacitor 150 and a load 160. The voltage across the parallel coupling of capacitor 150 and load 160 continues to increase until reaching a first predetermined value (a maximum threshold), at which time a HS_DRV low control signal opens high switch 120, and a LS-DRV high control signal closes low stitch 130.

After opening high switch 120 and closing low switch 130, a voltage across capacitor 150 (and hence load 160, coupled in parallel) begins to decay. This decay can be because both inductor 140 and capacitor 150 are sourcing current to load 160. The voltage across parallel capacitor 150 and load 160 continues to decrease until reaching a second predetermined value (a minimum threshold), at which time the HS-DRV high control signal closes high switch 120, and LS_DRV low control signal opens low switch 130.

As mentioned above, the voltage across the capacitor 150 (and load 160) can vary. If a charging cycle/response time of the voltage regulator 100 (i.e., the time between consecutive ramp-ups of I_{Lout}) is too long, the voltage across the capacitor 150 may dip below an acceptable value. The variance of the voltage across capacitor 150 may be reduced by decreasing a charging cycle/response time of the voltage regulator 100, such as by shortening the time period between consecutive ramp-ups of I_{Lout}. However, as the charging/cycle response time of the voltage regulator 100 decreases, component degradation of the voltage regulator 100 can be exacerbated.

### BRIEF DESCRIPTION OF THE DRAWINGS

FIG. 1 is a schematic diagram of a prior art voltage regulator.

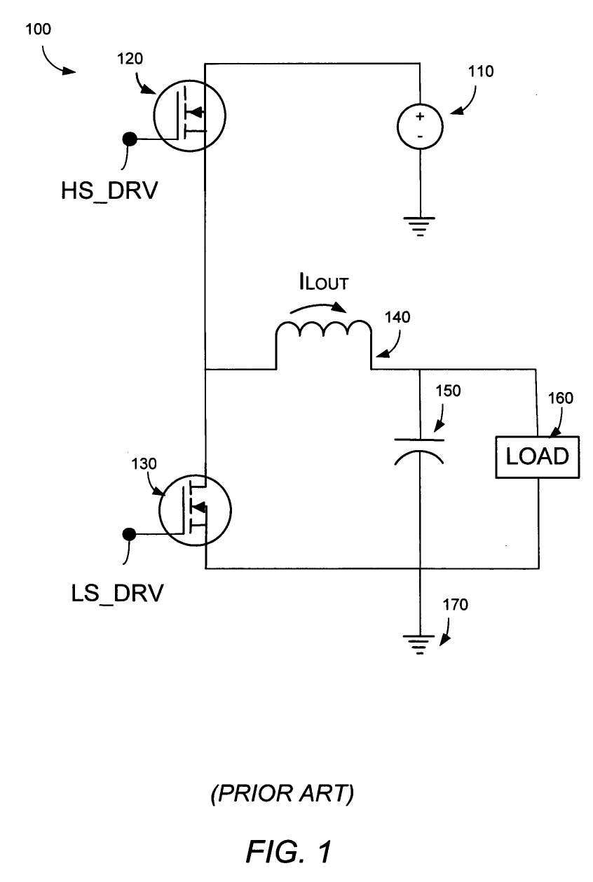

FIG. 2 is a schematic diagram of a voltage regulator according to some embodiments.

FIG. 3 comprises a diagram of a process according to some embodiments.

FIG. 4 is a graph of various current and control signals vs. time according to some embodiments.

FIG. 5 is a schematic diagram of a voltage regulator according to some embodiments.

FIG. 6 is a graph of various current and control signals vs. time according to some embodiments.

FIG. 7 is a block diagram of a voltage regulator system according to some embodiments.

### DETAILED DESCRIPTION

For the purpose of various examples in the present Application, a control signal which causes an associated switch to open will be referred to as a “low” control signal, and a control signal which causes an associated switch to close will be referred to as a “high” control signal. “Low” and “high” do not necessarily describe relative voltage levels of the two signals. For example, a low control signal may exhibit a greater voltage than a high control signal in some embodiments. Other implementations of these control signals are realizable in other embodiments.

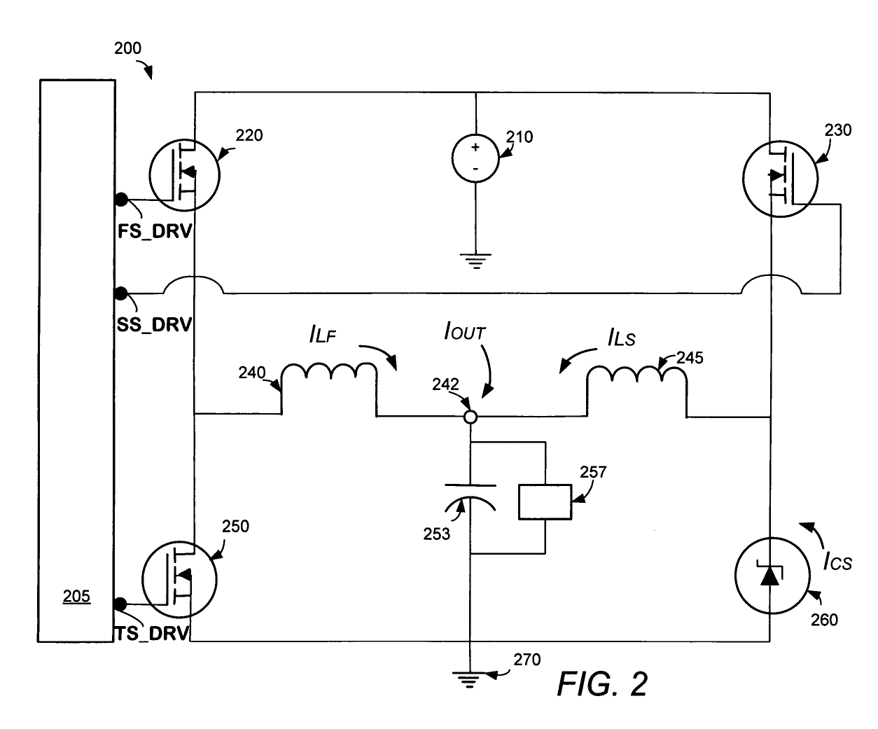

FIG. 2 is a schematic diagram of a voltage regulator (“regulator”) 200. Regulator 200 includes a DC voltage source 210 coupled to a first switch 220. A driver 205 is also coupled to first switch 220. In some possible embodiments, driver 205 includes a timing circuit (not illustrated). In some possible embodiments, driver 205 includes a combination of “flip-flops”, logic circuits and one or more operational amplifiers, although driver 205 may also be implemented by any suitable combination of discrete components, integrated circuits, and/or software.

Driver 205 applies a first switch control signal (FS_DRV) to first switch 220. The output of first switch 220 is coupled to a first inductor 240. First inductor 240 is coupled to a capacitor 253 and a load 257, such as an integrated circuit (IC), at a node 242. Capacitor 253 and load 257 may be coupled in parallel between the node 242 and a ground 270.

Regulator 200 also includes a second switch 230, such as a metal oxide semi-conducting field effect transistor (MOSFET), coupled to DC voltage source 210. The driver 205 is also coupled to second switch 230. Driver 205 applies a second switch control signal (SS_DRV) to second switch 230. An output of second switch 230 is coupled to a second inductor 245. The second inductor 245 is also coupled to the capacitor 253 and load 257 at node 242.

Regulator 200 also includes a third switch 250. The driver 205 is coupled to third switch 250. Driver 205 applies a third switch control signal (TS_DRV) to third switch 250. An input of third switch 250, the capacitor 253 and the load 257 may be coupled to ground 270. An output of third switch 250 is coupled to both the output of first switch 220 and also to first inductor 240.

In some embodiments, regulator 200 also includes a current conveying device 260 that is coupled between ground 270 and second inductor 245 and is also coupled to the output of second switch 230. In some embodiments, current conveying device 260 may be a self-commutating switch, e.g., an unidirectional switch or rectifier, or the like, to act in a free-wheeling manner.

For ease of explanation, the current of first inductor 240 is referred to as “I_{LF}”, and the current of the second conductor 245 is referred to as “I_{LS}.” Generally, second switch 230 may be transitioned to a closed state in concert with a closing of first switch 220, effectively beginning a charge cycle of first and second inductors 240, 245. According to some embodiments, first inductor 240 and second inductor 245 may be connected in parallel, delivering current more quickly and with a faster response time to capacitor 253 to load 257, than is possible with a conventional buck regulator.

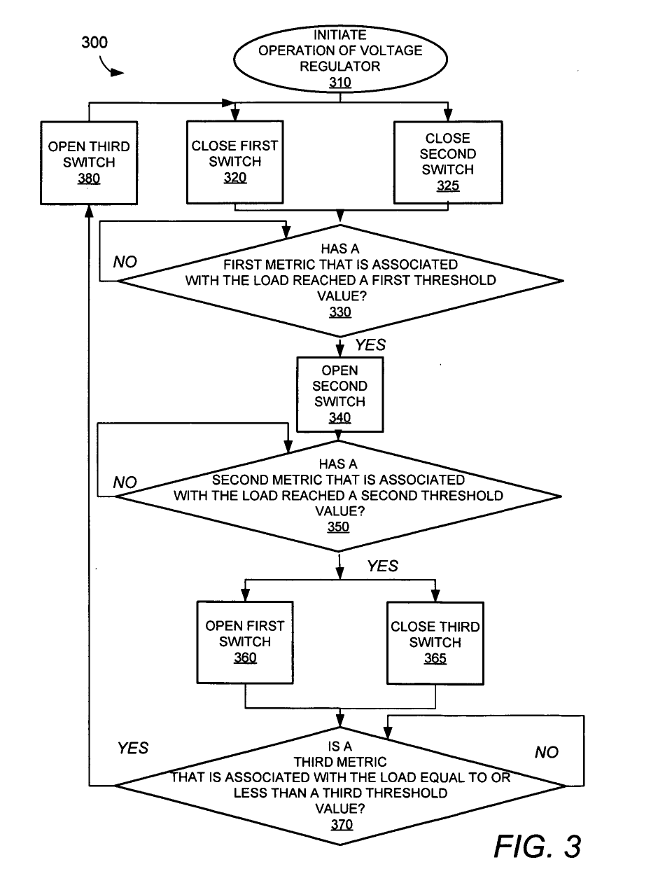

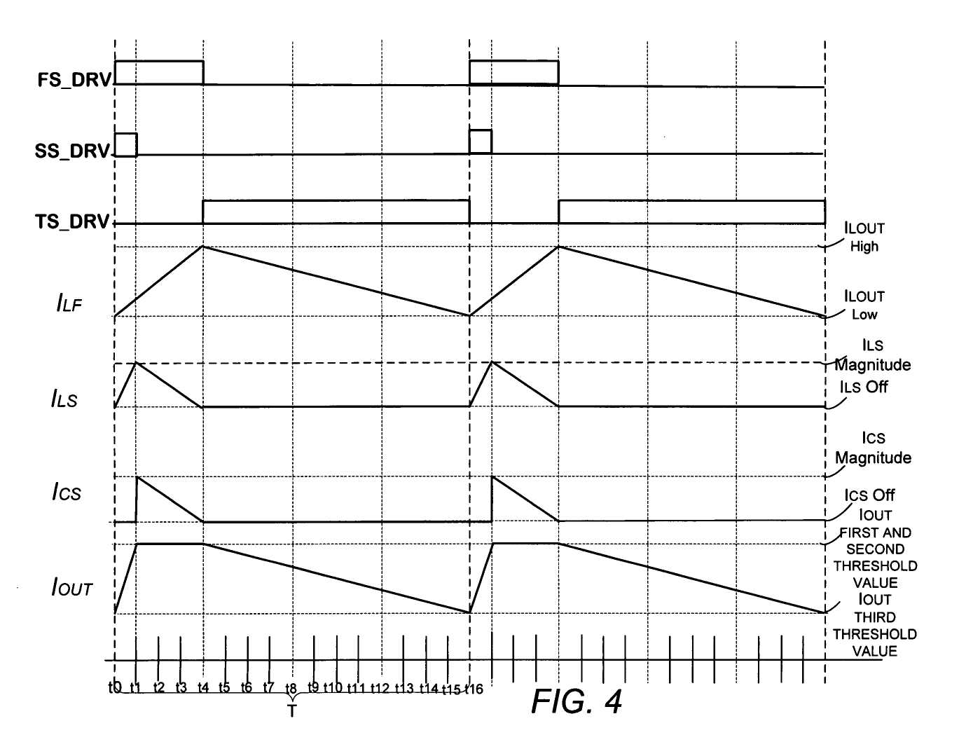

FIG. 3 is a flow diagram of process 300 according to some embodiments. Process 300 illustrates a procedure or procedures executed by voltage regulator 200 according to some embodiments. Accordingly, process 300 will be described with respect to the embodiment of FIG. 2 and also the timing diagram of FIG. 4. However, process 300 may be executed by any suitable combination of discrete components, integrated circuits, and/or software.

After initiating operation in 310, first switch 220 and second switch 230 of voltage regulator 200 are closed at 320 and 325, respectively. In some embodiments, 320 and 325 occur substantially simultaneously.

More specifically, regulator 200 may be operated at 320 as follows, as illustrated in conjunction with timing diagrams of FIG. 4. At to, driver 205 applies a FS_DRV high control signal to first switch 220. Furthermore, driver 205 applies a TS_DRV low control signal to third switch 250 at 325. The TS_DRV low control signal increases a first current (I_{LF}) through first inductor 240, as is illustrated in FIG. 4. (In FIG. 4 it is assumed that there is a high {first} threshold value of I_{LF} and a low {second} threshold value of I_{LF}, and some current is continually flowing through first inductor 240 to charge capacitor 253 and supply the load 257).

In 325, a SS_DRV high control signal is applied to second switch 230 from driver 205. In some embodiments, this occurs substantially simultaneously with the application of the FS_DRV high control signal to first switch 220 and the application of the TS_DRV low control signal to third switch 250. Closing second switch 230 allows current I_{LS} to start to flow through second inductor 240. I_{LS} charges capacitor 253 (and supplies load 257) in parallel with I_{LF} of first inductor 240 to generate I_{Lout}, the total combined current sunk into capacitor 253 and load 257.

As is illustrated in FIG. 4, I_{LF} increases over time (starting from t₀) from a low threshold current. I_{LS} also increases from a zero current since the change in current through an inductor is proportional to the voltage impressed upon it. These increases are due at least in part to a voltage being impressed across the first and second inductors 240, 245 from voltage source 210. Therefore, Iₒᵤₜ also increases over time. In t₀−t₁ of FIG. 4, in some embodiments, the change of current Iₒᵤₜ over time is a function of the change of I_{LF} plus the change of I_{LS}. This function may be represented by d/dt Iₒᵤₜ=ƒ(d/dt I_{LF}+d/dt I_{LS}), with d/t I_{LS} a positive value. 320 and 325 each advance to 330.

In 330, driver 205 determines whether a first metric associated with load 257 has reached a first threshold value. The first metric may comprise the value of Iₒᵤₜ of capacitor 253 and load 257, a voltage across load 257, or a selected time interval. If the threshold value has not been reached, the determination of 330 is repeated at a later time. If the first metric has reached the first threshold value, 330 advances to 340. In some embodiments, the first threshold value is an upper threshold value. In 340, the second switch 230 is opened. 340 advances to 350.

Examining the operation of regulator 200 at 330 as illustrated in FIG. 4, second switch 230 is closed until time t₁, whereupon a SS_DRV low control signal may be applied to second switch 230 to open second switch 230. As is illustrated in FIG. 4, I_{LS} increases at a steady rate and peaks at t₁, and then steadily decreases after second switch 230 was opened at t, at 330, until I_{LS} reaches zero at t₄. As is also illustrated in FIG. 4, the current sunk in capacitor 253 and load 257 (Iₒᵤₜ) peaks at t₁, then remains substantially constant until t₄, when I_{LS} reaches zero. Iₒᵤₜ remains substantially constant because, as first inductor 240 continues to increase its current I_{LF} delivered to capacitor 253 and load 257 from t₁ to t₄, second inductor 245 starts to decrease its current, I_{LS}, as a function of the voltage across the second inductor 245, and the inductance of second inductor 245. In other words, second inductor 245 siphons off at least some of the increase in I_{LF} from first inductor 240. In some embodiments, although the current I_{LS} is decreasing from t₁−t₄, its magnitude is never less than zero as defined with reference to capacitor 253 and load 257. Capacitor 253 and load 257 are charged by the increasing I_{LF} and the decreasing, but still non-zero, I_{LS} current. In t₂−t₄ of FIG. 4, a change of current over time for Iₒᵤₜ to capacitor 253 and load 257 is a function of the change of I_{LF} through first inductor 240 plus the change of I_{LS} through second inductor 245. This fraction may be represented by d/dt Iₒᵤₜ=ƒ(d/dt I_{LF}+d/dtI_{LS}), with d/dtI_{LS} a negative value.

However, once current I_{LS} reaches zero, current conveying device 260 ensures that no current will pass from second inductor 245 through current device 260 to ground 270. In FIG. 4, a current through current conveying device 260 is labeled as I_{CS}. As is illustrated, once second switch 230 opens at t₁ at 330, I_{CS} flows through current conveying device 260 until I_{LS} reaches zero at t₄, at which point current conveying device 260 blocks current from flowing from second conductor 245 through current conveying device 260 to ground 270.

In some exemplary embodiments, the change in current I_{LF} in first inductor 240 during t₁ to t₄ is equal to the change of the current I_{LS} through second inductor 245. As second inductor 240 siphons off at least some of the increase in I_{LF} from first inductor 240 as discussed above, a substantially constant current may be provided to capacitor 253, as is illustrated in Iₒᵤₜ of FIG. 4 from time t₂ to t₄.

In 350, it is determined if a second metric that is associated with load 257 has reached a second threshold value. In some embodiments, the second metric is a current into the capacitor 253 and load 257 (i.e., the first current Iₒᵤₜ), the voltage across the capacitor 253, or a selected time interval. In some embodiments, the second threshold value is also an upper threshold value. If the second metric has not reached the second threshold value, 350 loops back to 350 to execute the determination at a later time. If the second metric reaches the second threshold value, 350 advances to 360 and 365.

In reference to process 300, in 350, driver 205 may check whether I_{LF} has reached its maximum allowable current through first inductor 240, whether the siphon current through second inductor 245 is now zero, or whether time t₄ has occurred. If so, 350 advances to 360 and 365. In some embodiments, the second metric equals the first metric. In some embodiments, 360 and 365 are initiated substantially simultaneously.

First switch 220 is opened at 360, and third switch 250 is closed at 365. In some embodiments of 360 and 365, driver 205 applies the FS_DRV low control signal to first switch 220, and applies the TS_DRV high control signal to third switch 250 at substantially the same time. Opening first switch 220 and closing third switch 250 reverses the polarity of a voltage across first inductor 240, as the first inductor 240 is now coupled in parallel with capacitor 253 and load 257. Because the polarity of the voltage applied across first inductor 240 is reversed, the current through first inductor 240 (I_{LF}) begins to decrease, as is illustrated in I_{LF} from t₄ through t₁₆ in FIG. 4. Again, since the change in current through an inductor is proportional to the voltage impressed upon it, I_{LF} begins to continuously decrease due to an opposite voltage being impressed across the first inductor 240. In t₄−t₁₆ of FIG. 4, and starting at 350, 355, onwards, a change of current over time for Iₒᵤₜ to capacitor 253 and load 257 is a function of the change of I_{LF} through first inductor 240 plus the change of I_{LS} through second inductor 245, or d/dt Iₒᵤₜ=ƒ(d/dt I_{LF}), with d/dt I_{LF} a negative value.

It is determined if a third metric that is associated with capacitor 253 is equal to or less than a third threshold value at 370. In some embodiments, the third metric is a current into the capacitor 253 and load 257 (e.g., the current Iₒᵤₜ) a voltage across the capacitor 253, or a selected time interval. If the third metric is not equal to or less than the third threshold value, 370 loops back to execute the determination at a later time. If the third metric is equal to or less than the third threshold value, flow 300 continues to open the third switch 250 at 380.

According to some embodiments of 370, Iₒᵤₜ continues to decline until t₁₆, at which point Iₒᵤₜ to capacitor 253 and load 257 is equal to or less than the third threshold value. Next, at t₁₆, driver 205 applies TS_DRV low control signal to third switch 250 at 380. Driver 205 also applies FS_DRV high control signal to first switch 220 in 320, and SS_DRV high control signal to second switch 230 at 325 substantially simultaneously with the application of the TS_DRV low control signal to third switch 250 at 380.

According to some embodiments of process 300, driver 205 determines whether to stop delivering current to capacitor 253 and load 257 at 370. This determination can occur, for instance, if load 257 is to be disabled. If the option of stopping delivering current to capacitor 253 and load 257 is taken, the third metric may not be evaluated. Instead, first switch 220 and second switch 230 are both left open and third switch 230 is left closed after t₁₆, thereby draining capacitor 253 and maintaining regulation of voltage across load 257.

In regulator 200, in some embodiments, second inductor 245 may be sized to appropriately augment a rate of change of the current of first inductor 240. In some embodiments, the inductance of second inductor 245 (L 245=1/((1/L_{TOTAL})−(1/L 240)). L_{TOTAL} is defined below. In some embodiments, both first inductor 240 and second inductor 245 are operating in parallel during 330.

The net “total system” inductance of regulator 200 (L_{TOTAL}) then may be as follows:
L_{TOTAL}=1/((1/L 240)+(I/L 245)).

This L_{TOTAL} inductance magnitude results in a desired (non-overshooting) transient “droop boosting” current injected at node 242, such as illustrated between in I_{CS} between to and t₄ in FIG. 4. Therefore, the boost inductor may be sized:
L 245=1/((1/L_{TOTAL})−(1/L 240)).

In some embodiments, the inductance of second inductor 245 may be sized based on the relationship:
L 245=L240 (T_{ON}/T_{OFF}).

In regulator 200, in some embodiments, second switch 230 only operates at a fraction of the time that first switch 220 operates, i.e., first switch 220 and first inductor 240 are designed to conduct the majority of the load current Iₒᵤₜ. Second switch 230 and second inductor 245 augment a demand of load 257, especially an initial transient load of load 257. second switch 230 and second inductor 245 are not dissipating power when they are not augmenting current. In some embodiments, use of second switch 230 and second inductor 245 are designed to maximize a transient response of load 257 while minimizing a static loading of regulator 200.

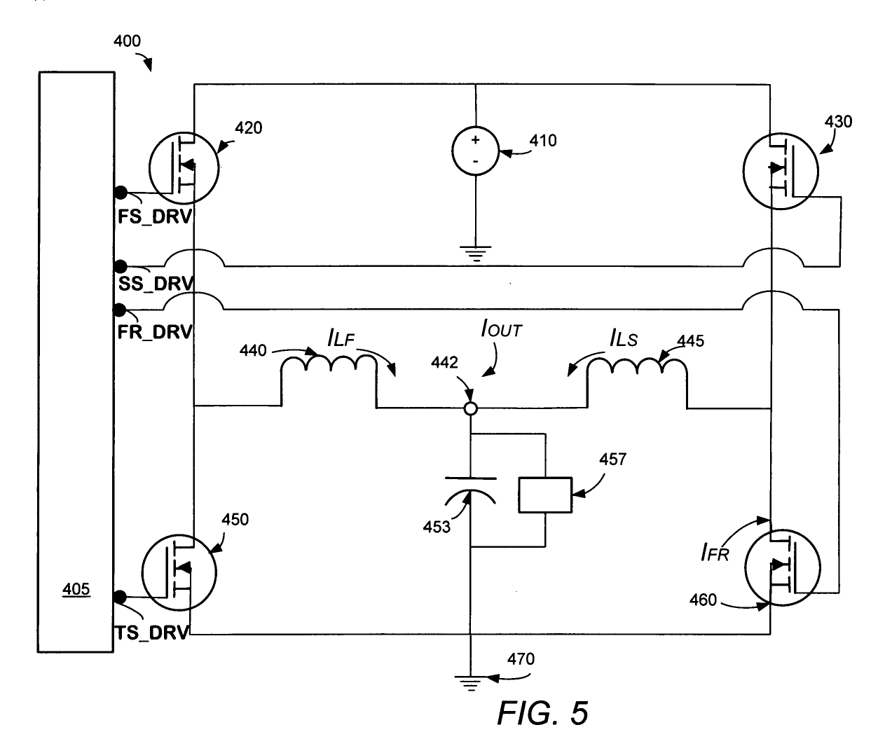

FIG. 5 illustrates alternative embodiments of a voltage regulator 400. Regulator 400 includes a DC voltage source 410 coupled to a first switch 420. A driver 405 is also coupled to first switch 420. Driver 405 applies the FS_DRV control signal to first switch 420. An output of first switch 420 is coupled to a first inductor 440. First inductor 440 is coupled to a capacitor 453 and a load 457, such as an IC, at a node 442. Capacitor 453 and load 457 may be coupled in parallel between the node 442 and a ground 470.

Regulator 400 also includes a second switch 430, such as a MOSFET, coupled to DC voltage source 410. The driver 405 is also coupled to a second switch 430. Driver 405 applies the SS_DRV control signal to second switch 430. An output of second switch 430 is coupled to a second inductor 445. The second inductor 445 is also coupled to the capacitor 453 and load 457 at node 442.

Regulator 400 also includes a third switch 450. The driver 405 is coupled to third switch 450. Driver 405 applies the TS_DRV control signal to third switch 450. An input of third switch 450, the capacitor 453 and the load 457 may be coupled to ground 470. An output of third switch 450 is coupled to both the output of first switch 420 and also to first inductor 440.

In some embodiments, regulator 400 also includes a fourth switch 460. The driver 405 is coupled to fourth switch 460. Driver 405 applies a fourth switch (FR_DRV) control signal to fourth switch 460. Fourth switch 460 is coupled between ground 470 and second inductor 445, and is also coupled to the output of second switch 430. In some embodiments, fourth switch 460 is a current conveying device such as a MOSFET.

Regulator 400 can be used in a manner analogous to that described above with respect to regulator 200, but, instead of current conveying device 260 self-commutating to an “off” state when a current through second inductor 245 reaches zero, as described in relation to FIG. 2, fourth switch 460 is actively opened and closed by driver 405.

In some possible embodiments of process 300, the FR_DRV high control signal would also be applied to fourth switch 460 by driver 405 at 340, thereby closing fourth switch 460 substantially simultaneously with the opening of second switch 430 by driver 405 at 340. In some possible embodiments of process 300, the FR_DRV low control signal would also be applied to fourth switch 460 by driver 405 at 360, thereby opening fourth switch 460 substantially simultaneously with the opening of first switch 420 by driver 405 at 360 and the closing of third switch 450 by driver 405 at 365.

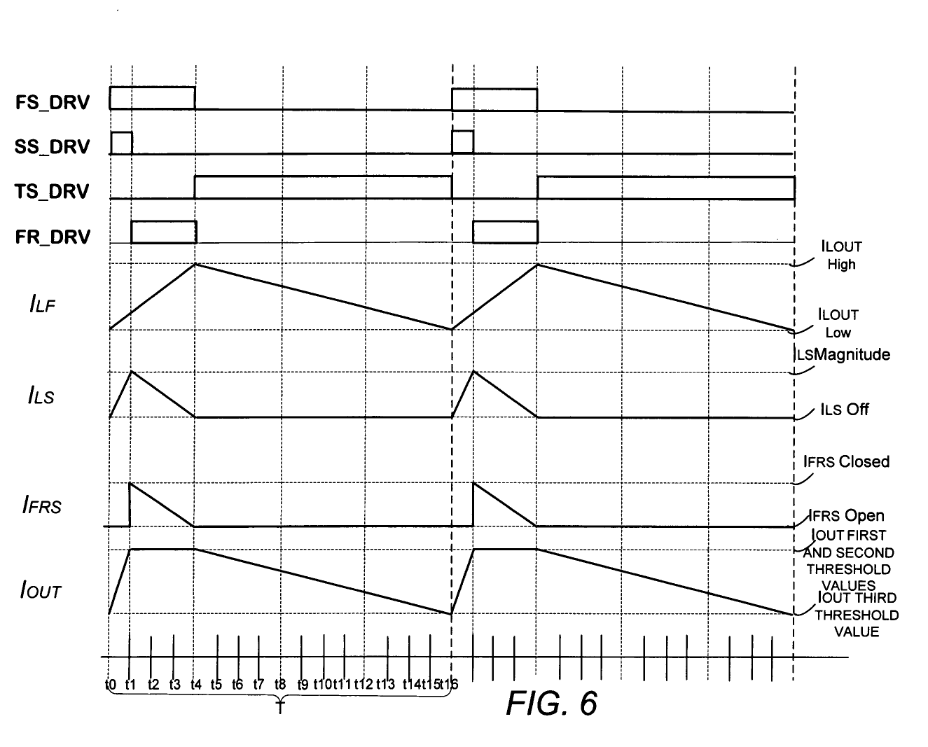

According to some embodiments, driver 405 sends a FR_DRV low control signal to fourth switch 460 from t₀ to t₁, keeping fourth switch 460 open. Once second switch 430 is opened at t₁, the FR_DRV high control signal is sent to fourth switch 460 also at t₁, thereby closing fourth switch 460 at 340. Fourth switch 460 is in a closed state until t₄. I_{LS} reaches zero at t₄, whereupon driver 405 sends the FR_DRV low control signal to fourth switch 460, thereby opening fourth switch at 360. Fourth switch 460 stays open from t₄−t₁₆. Generally, opening fourth switch 460 at t₄ helps to ensure that current through fourth switch 460 (I_{FRS}) does not flow from the second inductor 445 to ground 470. In some embodiments, I_{FRS} of FIG. 6 is substantially equal to I_{CS} of FIG. 4.

Use of current conveying device 260 of regulator 200 can lead to a simpler driver 205 than might be found with driver 405 of regulator 400, as driver 205 may not need to generate signal to sense, drive or otherwise account for fourth switch 460. However, fourth switch 460, such as a MOSFET, may be less expensive to purchase and install in regulator 400 than the current conveying device 260 would be to purchase and install in regulator 200, and may take up less circuit “real-estate.” However, regulator 400, including fourth switch 460, which may comprise a MOSFET, may be less expensive to produce than regulator 200 including current conveying device 260. Moreover, a physical footprint occupied by regulator 400 may be smaller than a footprint occupied by regulator 200.

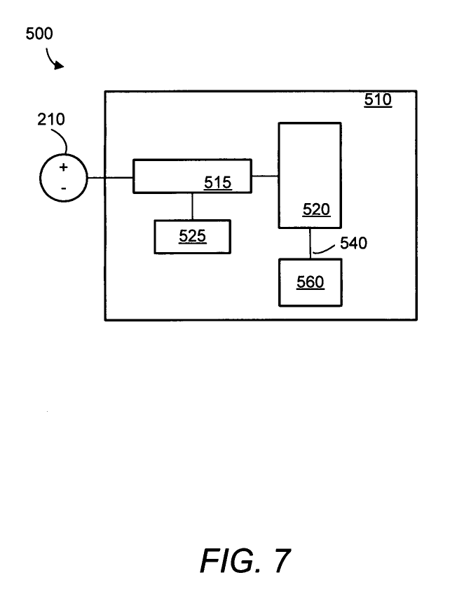

FIG. 7 illustrates a system 500 according to some embodiments. System 500 may execute process 300 associated with regulator 200 or a process associated with regulator 400. System 500 includes power supply 210, a voltage regulator 515, such as regulator 200 or regulator 400, an IC 520, a timer/sensor 525, and a memory 560. A motherboard 510 is coupled to voltage regulator 515, IC 520, timer sensor 525, and memory 560. System 500 may comprise components of a desktop computing platform, and memory 560 may comprise any type of memory for storing data, such as a Single Data Rate Random Access Memory, a Double Data Rate Random Access Memory, or a Programmable Read Only Memory. Motherboard 510 therefore includes signal lines of power bus 540 between IC 520 and memory 560. Similarly, motherboard 510 may route I/O signals between IC 560 and voltage regulator 515.

Voltage regulator 515 receives DC power from power supply 210 and regulates the DC power to provide regulated power to IC 520. In some embodiments, timer/sensor 525 senses conditions in voltage regulator 515. Timer/sensor 525 provides the sensed conditions to voltage regulator 515. Voltage regulator 515, in turn, may open and close its various switches based on the sensed conditions. In other embodiments, timer/sensor 525 measures the passage of time and provides time signals to voltage regulator 515, based on which the voltage regulator 515 may open and close its various switches.

The several embodiments described herein are solely for the purpose of illustration. Some embodiments may include any currently or hereafter-known versions of the elements described herein. Therefore, persons in the art will recognize from this description that other embodiments may be practiced with various modifications and alterations.

What is claimed is:

1. A system comprising:
a first switch comprising a first switch output;
a second switch comprising a second switch output;
a third switch comprising a third switch output coupled to the first switch output;
a first inductor coupled to the first switch output and the third switch output;
a second inductor coupled to the second switch output, wherein said first inductor and second inductor are coupled to each other at a node; and
a capacitor coupled to the node.

2. The device of claim 1, wherein the second switch is a metal oxide semiconductor field effect transistor.

3. The device of claim 1, wherein the first switch and second switch are closed, and the third switch is open.

4. The device of claim 1, wherein the capacitor is coupled to a ground.

5. The device of claim 1, further comprising a current conveying device having an output and an input, wherein the output is coupled to the second inductor and the input is coupled to a ground.

6. The device of claim 5, wherein the current conveying device comprises a self-commutating switch to operate in a free-wheeling manner.

7. The device of claim 5, wherein the current conveying device comprises a fourth switch driven by a driver.

8. The device of claim 1, wherein an inductance of the second inductor is less than an inductance of the first inductor.

9. The device of claim 1, further comprising a driver to open and close the first switch, the second switch and the third switch.

10. The device of claim 9, wherein the driver is to ensure that the first switch and the third switch are not simultaneously both in an open or closed state.

11. The device of claim 9, wherein the driver is to close the first and second switches substantially simultaneously, and then to open the second switch before closing the third switch.

12. The device of claim 1, further comprising an input of the first switch and the second switch, and a voltage source coupled to the input of the first switch and the input of second switch.

13. A method, comprising:
closing a first switch of a voltage regulator;
closing a second switch of the voltage regulator;
opening the second switch, wherein the first switch is not opened between the closing of the second switch and an opening of the second switch;
opening the first switch after the opening of the second switch; and
closing a third switch of the voltage regulator, wherein the third switch is closed at substantially the same time as the first switch is opened.

14. The method of claim 13, further comprising:
determining that a first metric associated with a load of the voltage regulator has reached a first threshold value; and
opening the second switch in response to the determination.

15. The method of claim 14, wherein the first metric associated with the load is selected from the group consisting of a current into the capacitor and the load, a voltage across the load, and a time interval.

16. The method of claim 13, further comprising:
determining that a second metric associated with a load of the voltage regulator has reached a second threshold value;
opening the first switch in response to the determination; and
closing the third switch in response to the determination.

17. The method of claim 13, further comprising:
determining that a third metric associated with a load of the voltage regulator is equal to or less than a third threshold value, closing the first switch in response to the determination; and
opening the third switch in response to the determination.

18. The method of claim 13, further comprising:
determining that a first metric associated with a load of the voltage regulator has reached a first threshold value; and
closing a fourth switch in response to the determination.

19. The method of claim 13, further comprising:
determining that a second metric associated with a load of the voltage regulator has reached a second threshold value; and
opening a fourth switch in response to the determination.

20. The method of claim 13, wherein the second switch and the first switch are closed at substantially the same time.

21. A system, comprising:
a motherboard;
a microprocessor coupled to the motherboard;
a double data rate memory coupled to the integrated circuit;
a voltage regulator to provide a supply voltage to the microprocessor, the voltage regulator comprising:
a first switch comprising a first switch output;
a second switch comprising a second switch output;
a third switch comprising a third switch output coupled to the first switch output;
a first inductor coupled to the first switch output and the third switch output;
a second inductor coupled to the second switch output, wherein said first inductor and second inductor are coupled to each other at a node; and
a capacitor coupled to the node.

22. The system of claim 21, wherein the second switch is a metal oxide semiconductor field effect transistor.

23. The system of claim 21, wherein the integrated circuit comprises a processor.

24. The system of claim 21, further comprising a current conveying device having an output and an input, wherein the output is coupled to the second inductor and the input is coupled to a ground.

25. The system of claim 24, wherein the current conveying device comprises a self-commutating switch to operate in a free-wheeling manner.

26. The system of claim 24, wherein the current conveying device comprises a fourth switch driven by a driver.

27. The system of claim 21, further comprising a driver to open and close the first switch, the second switch and the third switch.

28. The system of claim 27, wherein the driver is to ensure that the first switch and the third switch are not simultaneously both in an open or closed state.

29. The system of claim 27, wherein the driver is to close the first and second switches substantially simultaneously, and then to open the second switch before closing the third switch.
